(19) United States
(12) Patent Application Publication
(10) Pub. No.: US 2015/0169180 A1
(43) Pub. Date: Jun. 18, 2015

(54) REARRANGING ICONS ON A DISPLAY BY SHAKING

(71) Applicant: Acer Incorporated, New Taipei City (TW)

(72) Inventors: Hsuan-Wei LIN, New Taipei City (TW); Chien-Hsun WU, New Taipei City (TW); Yung-Shih CHI, New Taipei City (TW)

(21) Appl. No.: 14/311,796

(22) Filed: Jun. 23, 2014

(30) Foreign Application Priority Data
Dec. 13, 2013 (TW) 102146240

(51) Int. Cl. G06F 3/0481; G06F 3/01

(52) U.S. Cl. CPC G06F 3/04817; G06F 3/017

(57) ABSTRACT

Presented herein are techniques to enable a user of an electronic device to re-arrange icons displayed on a display of the electronic device. In one embodiment, a method includes detecting a first movement of the electronic device, detecting a second movement of the electronic device, and in response to the first movement and the second movement, re-arranging groups of icons displayed on the display of the electronic device.

### RELATED APPLICATION DATA

This application claims priority under 35 U.S.C. §119 to Taiwan patent application TW 102146240, filed on Dec. 13, 2013, the disclosure of which is incorporated herein by reference in its entirety.

### TECHNICAL FIELD

### Background

Today's information society continues to increasingly rely on consumer electronic devices including, but not limited to, smartphones, e-books, and tablet computers, among other devices. These devices enable people to gain access to, for example, the Internet while mobile, or stationary. One of the particularly notable features of such consumer devices, and one that has increased the popularity of such devices, is the touch screen. A touch screen, in combination with an associated display, enables a user to perform various operations with the electronic device including viewing graphical and text information, as well as simultaneously inputting text via a displayed keyboard or providing touch input responsive to a given display.

Recently, the distinction between smartphones and tablet computers has diminished. That is, smartphones are now being manufactured with relatively large display screen sizes, e.g., on the order of 5.8-6.2 inches (usually measured diagonally across the display). Such devices are sometimes referred to in the industry as “phoneblets,” i.e., a combination of a phone and a tablet. While such devices offer significant advantages to users, there are also some disadvantages that result from the increased size screen for a device that has conventionally been used mainly as a mobile telephone.

FIGS. 1A and 1B show a phoneblet (hereinafter “electronic device”) 100 having a display 150 on which is displayed a plurality of icons 160 arranged, substantially, in a grid pattern. FIG. 1A depicts electronic device 100 being held in the left hand of a user with a left thumb 190L in contact with display 150 (or associated touch screen). FIG. 1B depicts electronic device 100 being held in the right hand of a user with a right thumb 190R in contact with display 150. As can be seen, several icons 160 can be easily reached by the user's thumb, while other icons 160 may not be so easily reachable. Specifically, several icons within upper right corner of the display denoted by circle 180UR and icons 160 within lower left corner of the display denoted by circle 180LL are not easily reachable by user's left thumb 190L. Similarly, several icons within the upper left corner of the display denoted by circle 180UL and icons 160 within the lower right corner of the display denoted by circle 180LR are not easily reachable by user's right thumb 190R.

To address the icon reachability issues described above, embodiments of the invention described herein provide a methodology by which icons can be re-arranged on the display so that a user can more easily reach a given icon 160.

### SUMMARY

In accordance with certain embodiments presented herein, a method is provided to enable a user of an electronic device to re-arrange icons displayed on a display of the electronic device. The method comprises detecting a first movement of the electronic device, detecting a second movement of the electronic device, and in response to the first movement and the second movement, re-arranging groups of icons displayed on the display of the electronic device. In one implementation, the groups of icons are rotated around a center of the display in a clockwise or counter-clockwise direction. For example, icons in an upper left corner of the display are moved to the upper right corner of the display, and the icons originally in the upper right corner of the display are moved to the lower right corner of the display, and so on, which, in this case, is consistent with clockwise rotation.

An apparatus for performing the indicated method is also presented.

### BRIEF DESCRIPTION OF THE DRAWINGS

Embodiments are described herein in conjunction with the accompanying drawings, in which:

FIGS. 1A and 1B show an electronic device being held by a user's left hand and right hand, respectively;

FIG. 2 illustrates an example electronic device configured to enable icon re-arrangement in accordance with an embodiment of the present invention;

FIG. 3 shows a plurality of icons displayed on a display of an electronic device and classified into respective regions of the display in accordance with an embodiment of the present invention;

FIG. 4 shows a gesture that may be performed when the electronic device is held by a left hand of a user and that results in a re-arrangement of icons on the display in accordance with an embodiment of the present invention;

FIG. 5 shows a resulting clockwise rotation of icons displayed on the display resulting from the gesture described in connection with FIG. 4 in accordance with an embodiment of the present invention;

FIG. 6 shows a gesture that may be performed when the electronic device is held by a right hand of a user and that results in a re-arrangement of icons on the display in accordance with an embodiment of the present invention;

FIG. 7 shows a resulting counter-clockwise rotation of icons displayed on the display resulting from the gesture described in connection with FIG. 6 in accordance with an embodiment of the present invention;

FIG. 8 is a flow chart illustrating example processing steps performed by the electronic device in accordance with an embodiment of the present invention; and

FIG. 9 depicts a flow chart illustrating example processing steps in accordance with another embodiment of the present invention.

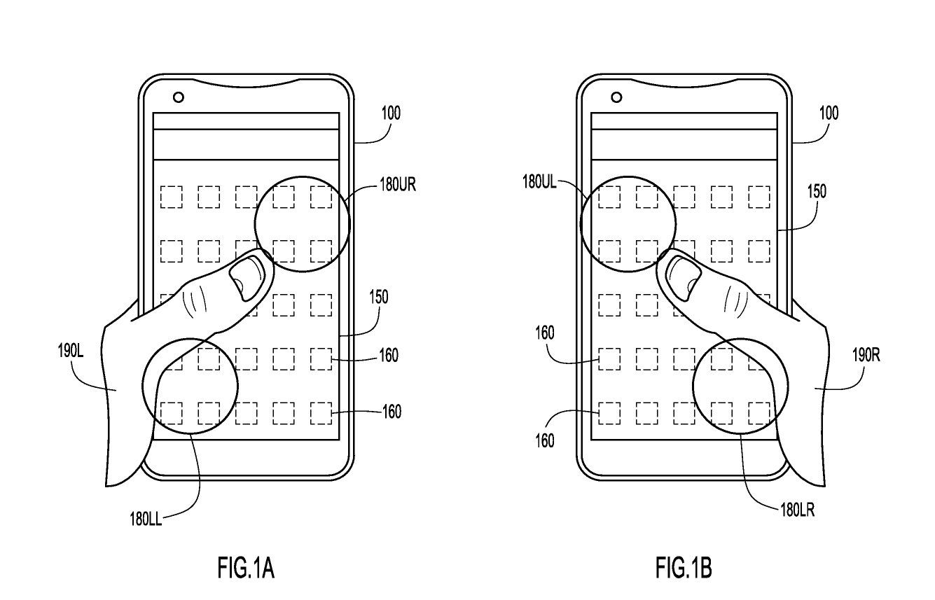

### DESCRIPTION OF EXAMPLE EMBODIMENTS

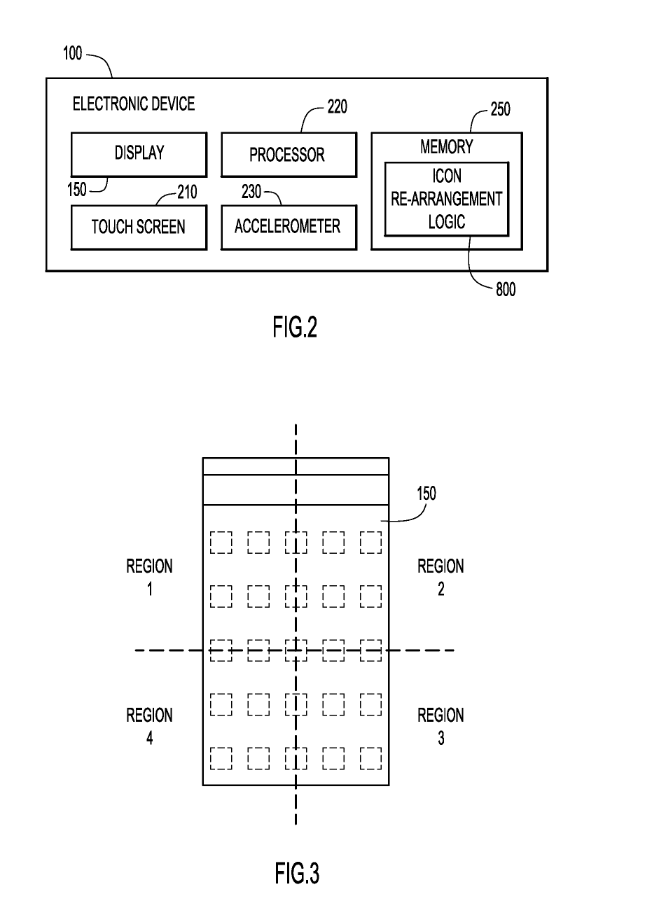

Reference is made to FIG. 2, which illustrates an example electronic device 100, such as a smartphone, phoneblet, etc., configured to enable icon re-arrangement in accordance with embodiments of the present invention. Electronic device 100 includes a display 150 (e.g., a liquid crystal display, etc.) and a touch screen 210 (capacitive, resistive, etc.) that may be disposed on top of display 150 and is responsive to touch input made by a user. Electronic device 100 further includes a processor 220, an accelerometer 230 and memory 250. Memory 250 may store icon re-arrangement logic 800, the function of which will be explained in more detail later herein.

Processor 220 may be a microprocessor or microcontroller that is configured to execute program logic instructions (i.e., software) for carrying out various operations and tasks described herein. For example, processor 220 is configured to execute icon re-arrangement logic 800 that is stored in memory 250 to react appropriately to a detected gesture performed by a user. Memory 250 may comprise read only memory (ROM), random access memory (RAM), magnetic disk storage media devices, optical storage media devices, flash memory devices, electrical, optical or other physical/tangible memory storage devices.

The functions of processor 220 may be implemented by logic encoded in one or more tangible computer readable storage media (e.g., embedded logic such as an application specific integrated circuit, digital signal processor instructions, software that is executed by a processor, etc.), wherein memory 250 stores data used for the operations described herein and stores software or processor executable instructions that are executed to carry out the operations described herein.

Icon re-arrangement logic 800 may take any of a variety of forms, so as to be encoded in one or more tangible computer readable memory media or storage device for execution, such as fixed logic or programmable logic (e.g., software/computer instructions executed by a processor). In general, the icon re-arrangement logic 800 may be embodied in one or more computer readable storage media encoded with software comprising computer executable instructions and when the software is executed operable to perform the operations described herein.

Accelerometer 230 may be a two-axis or three-axis accelerometer that is commonly incorporated in a handheld electronic device and that may be used to monitor an orientation of the electronic device to, for instance, determine whether to display content in portrait or landscape mode, among other functions. Accelerometer 230 may also be used to, among other things, detect tilt, shake, rotation or swing of electronic device 100. As will be explained in more detail in connection with the embodiments described herein, accelerometer 230 is used to detect a first gesture or movement and a second gesture or movement, following the first gesture or movement, and then icon re-arrangement logic 800 in combination with processor 220, responsive to the first movement and the second movement, is configured to modify the arrangement of ions 160 on display 150.

FIG. 3 shows the plurality of icons 160 displayed on display 150 of electronic device 100 and classified into respective regions of the display. More specifically, FIG. 3 shows display 150 with icons 160 arranged in a substantially grid-like arrangement, and, in particular, in a 5×5 icon arrangement with five icons 160 in any given row and five icons 160 in any given column. Those skilled in the art will appreciate that the arrangement depicted is an example only and other arrangements are possible. With the depicted grid arrangement, icons 160 can be classified into four different regions: Region 1, Region 2, Region 3 and Region 4. As shown, Region 1 contains icons 160 disposed in a top left corner of display 150, Region 2 contains icons 160 disposed in a top right corner of display 150, Region 3 contains icons 160 disposed in a bottom right corner of display 150 and Region 4 contains icons 160 disposed in a bottom left corner of display.

As will be explained below, the respective groups of icons 160 in each of the Regions 1, 2, 3, 4 are automatically moved to an adjacent region in either a clockwise or counter-clockwise direction depending on a user's handling, movement or gesturing while holding electronic device 100. More specifically, when a user shakes electronic device 100 in a particular way, icons 160 on display 150 are moved to different positions such that a user can more easily reach icons that might have previously been difficult to reach when operating electronic device 100 with a single hand.

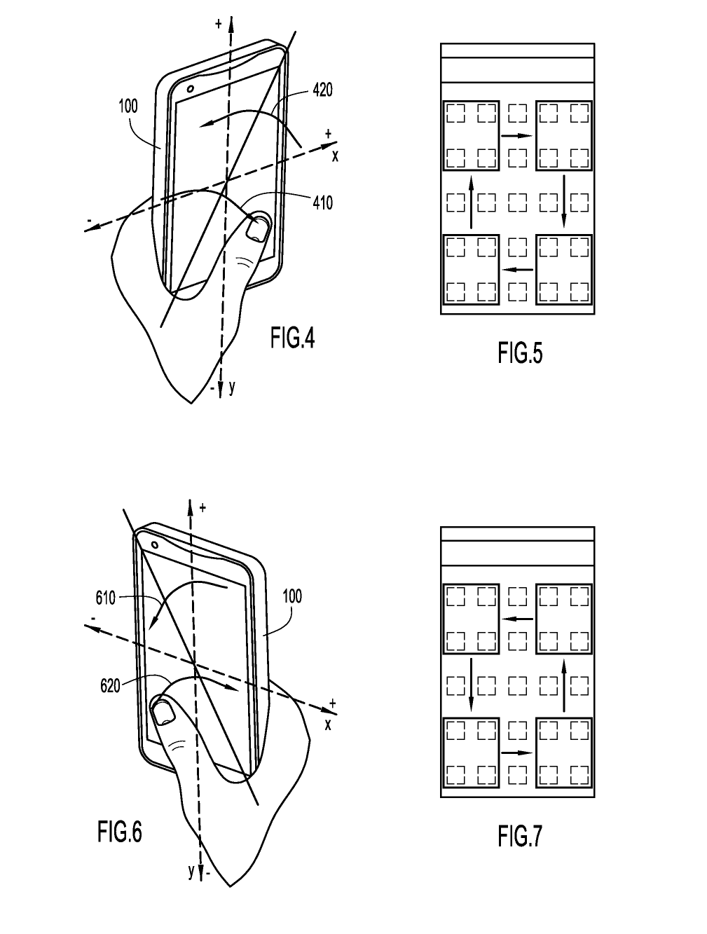

FIG. 4 shows a gesture that may be performed when the electronic device is held by a left hand of a user and that results in a re-arrangement of icons on the display. Specifically, when a user is holding electronic device 100 is his left hand and moves electronic 100 device in the direction indicated by arrow 410, this is considered movement or behavior 1. When the user thereafter moves electronic device 100 in the direction indicated by arrow 420, this is considered movement or behavior 2. In one possible implementation behavior 1 and behavior 2 are performed very close in time with respect to each other, e.g., within 0.5 second. In other words, behavior 1 in combination with behavior 2 may be considered a quick shake motion directed firstly away and then secondly back toward the user.

With respect to the x-axis and y-axis shown in FIG. 4, and for purposes of the instant embodiment, behavior 1 may be considered to be a movement in the positive x direction, in combination with a movement in the negative y direction. Behavior 2 may be considered to be a movement in the negative x direction, in combination with a movement in the positive y direction.

FIG. 5 shows a resulting clockwise rotation of icons displayed on the display resulting from the combination of behavior 1 and behavior 2 described in connection with FIG. 4. That is, when a user shakes electronic device 100 in accordance with behavior 1 and behavior 2, icons 160 in Region 1 are moved to Region 2. Icons 160 in Region 2 are moved to Region 3, icons in Region 3 are moved to Region 4, and icons 160 in Region 4 are moved to Region 1. In other words, as a result of the specified shake movement performed by the user and detected by accelerometer 230 and processed by icon re-arrangement logic 800, icons 160 that were previously in hard-to-reach areas of display 150 are moved to areas that can be more easily reached by a user operating electronic device 100 with one hand.

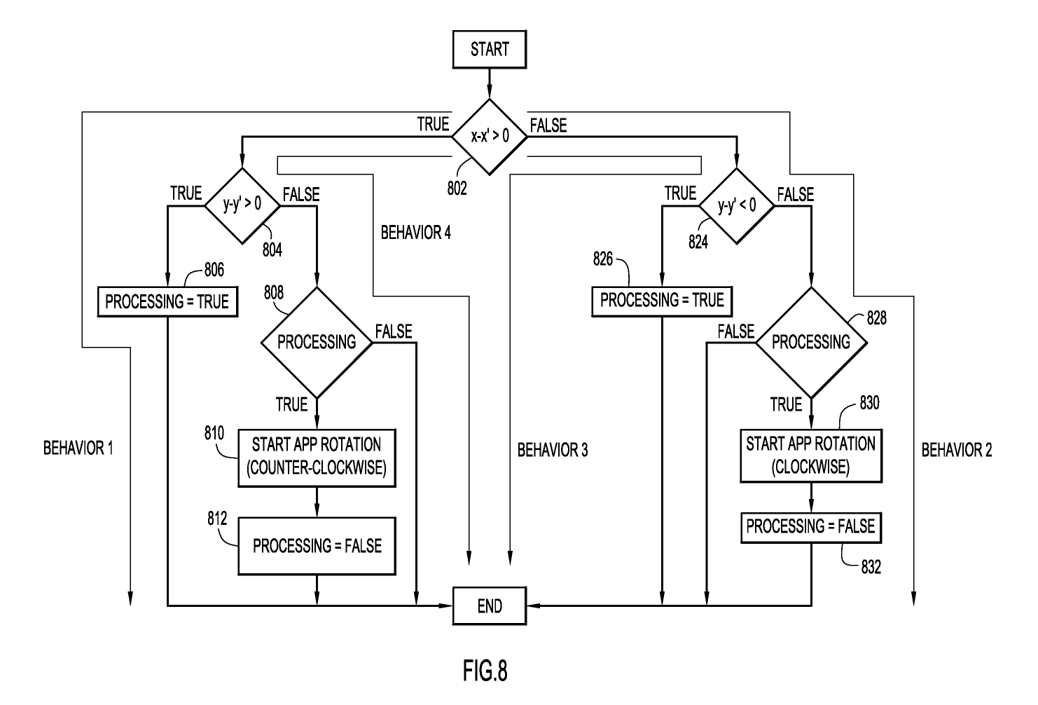

FIG. 6 shows a gesture that may be performed when the electronic device is held by a right hand of a user and that results in a re-arrangement of icons on the display. Specifically, when a user is holding electronic device 100 is his right hand and moves electronic device 100 in the direction indicated by arrow 610, this is considered movement or behavior 3. When the user thereafter moves electronic device 100 in the direction indicated by arrow 620, this is considered movement or behavior 4. In one possible implementation behavior 3 and behavior 4 are performed very close in time with respect to each other, e.g., within 0.5 second. In other words, behavior 3 in combination with behavior 4 may be considered a quick shake motion directed firstly away and then secondly back toward the user.

With respect to the x-axis and y-axis shown in FIG. 6, and for purposes of the instant embodiment, behavior 3 may be considered to be a movement in the negative x direction, in combination with a movement in the negative y direction. Behavior 4 may be considered to be a movement in the positive x direction, in combination with a movement in the positive y direction.

FIG. 7 shows a resulting counter-clockwise rotation of icons displayed on the display resulting from the combination of behavior 3 and behavior 4 described in connection with FIG. 6. That is, when a user shakes electronic device 100 in accordance with behavior 3 and behavior 4, icons 160 in Region 1 are moved to Region 4. Icons 160 in Region 4 are moved to Region 3, icons in Region 3 are moved to Region 2, and icons 160 in Region 2 are moved to Region 1. In other words, as a result of the specified shake movement performed by the user and detected by accelerometer 230 and processed by icon re-arrangement logic 800, icons 160 that were previously in hard-to-reach areas of display 150 are moved to areas that can be more easily reached by a user operating electronic device 100 with one hand.

In sum, behaviors 1-4 can be expressed as follows:
Behavior 1: X-axis increase, Y-axis decrease
Behavior 2: X-axis decrease, Y-axis increase
Behavior 3: X-axis decrease, Y-axis decrease
Behavior 4: X-axis increase, Y-axis increase

Those skilled in the art will appreciate that while the foregoing operations have been described such that all icons in a given region are moved to another region, the scope of the present invention should not be construed as being so limited. Specifically, in one possible implementation, electronic device 100 may provide a setting function in which a user can select or customize which icons are moved as a result of the specified shake movements. In another aspect of the invention, a “shake for icon re-arrangement enable” icon (not shown) might be provided. That is, electronic device 100 may be configured to permit a user to turn on or off (enable/disable) the shake function that re-arranges icons 160. Such a “shake for icon re-arrangement enable” icon might be displayed in, e.g., a center of display 150, and thus substantially always reachable even when operating electronic device 100 with a single hand. Such an icon, and related functionality, could be designed such that a user would need to touch the icon while performing the shake movement to provide an unambiguous indication that the user would like icons 160 to be re-arranged as a result of the specified shake motion.

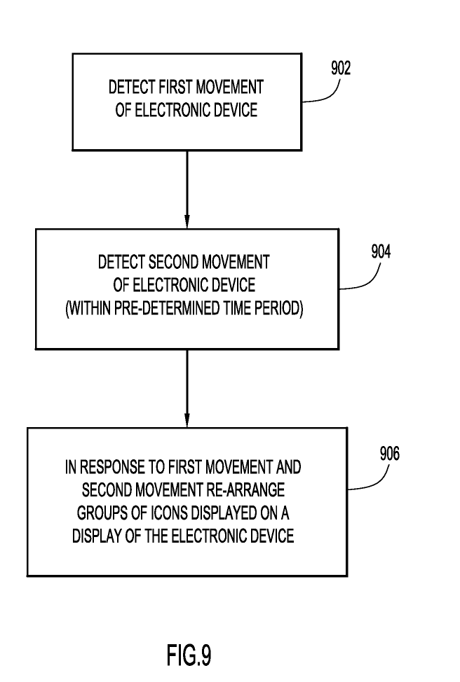

FIG. 8 is a flow chart illustrating example processing steps performed by electronic device 100, and in particular icon re-arrangement logic 800. At a high level, the process described below monitors x-axis and y-axis accelerations to determine which behaviors or movements, if any, are being performed and to react accordingly.

The process begins at 802 wherein it is determined whether the accelerometer indicates movement in a positive or negative x-axis direction. That is, it is determined whether x−x′>0, where x represents current x-axis data output by the accelerometer, and x′ represents prior x-axis data output by the accelerometer. If x is greater than x′ that means the electronic device is being moved in the positive x-axis direction (see, e.g., FIG. 4). At substantially the same time, it is determined at 804 whether y−y′>0, where y represents current y-axis data output by the accelerometer, and y′ represents prior y-axis data output by the accelerometer. If y is greater than y′ that means the electronic device is being moved in the positive y-axis direction. In the case of behavior 1 shown in FIG. 4, movement in the y-axis is negative. That is, behavior 1 can be summarized as X-axis increase, Y-axis decrease. If behavior 1 is detected, then at 806 a Boolean value for “processing” is set to TRUE.

“Processing” set to TRUE indicates that at least a part of a pair of shake movements has been made. If a second, related, movement is made in, e.g., a predetermined amount of time, then icon re-arrangement logic 800 is configured to cause icons on display 150 to be re-arranged, e.g., rotate around a given point on the display, such as a center point on the display.

To detect whether a second, related, movement is made, the process of FIG. 8 is again performed. Specifically, it is determined at 802 whether x−x′>0. If x is greater than x′ that means the electronic device is being moved in the positive x-axis direction (see, e.g., FIG. 4). For behavior 2, movement is made in the negative x-axis direction and thus the result of 802 is false. At substantially the same time, it is determined at 824 whether y−y′<0. If y is less than y′ that means the electronic device is being moved in the negative y-axis direction. In the case of behavior 2 shown in FIG. 4, movement in the y-axis is positive. Thus, the result of 824 is False. Proceeding to 828 it is determined whether “processing” is TRUE. If so, at 830 icons on the display are re-arranged, in this case in a clockwise direction. Then, at 832, “processing” is set to False so that a subsequent random movement consistent with behavior 2 does not unintentionally cause icon re-arrangement.

Detecting behavior 3 and related behavior 4 is similar to that described above with respect to behavior 1 and behavior 2, except the sequence path though the flow chart of FIG. 8 for behavior 3 passes through steps 802, 824 and 826. And the sequence path though the flow chart of FIG. 8 for behavior 4 passes through steps 802, 804, 808, 810 and 812.

FIG. 9 depicts a flow chart illustrating example processing steps in accordance with another embodiment of the present invention. At 902 a first movement of the electronic device is detected. At 904 a second movement of the electronic device is detected. At 906, in response to the first movement and the second movement, groups of icons displayed on the display of the electronic device are re-arranged. As noted, the re-arranging can include rotating the groups of icons in a clockwise or counter-clockwise direction.

The above description is intended by way of example only.

What is claimed is:

1. A method for arranging icons on a display of an electronic device, the method comprising:
detecting a first movement of the electronic device;
detecting a second movement of the electronic device; and
in response to the first movement and the second movement, re-arranging groups of icons displayed on the display of the electronic device.

2. The method of claim 1, wherein re-arranging comprises rotating the groups of icons in one of a clockwise or counter clockwise direction around a predetermined center point of the display.

3. The method of claim 1, wherein the groups of icons are grouped according to a quadrant in which the icons are displayed on the display.

4. The method of claim 1, wherein the groups of icons are grouped according to user input.

5. The method of claim 1, further comprising determining that the second movement occurs within a predetermined time after the first movement.

6. The method of claim 1, wherein detecting is performed using at least a two-axis accelerometer.

7. The method of claim 1, wherein a combination of the first movement and the second movement indicates whether the electronic device is being held by a right hand of a user or a left hand of a user.

8. The method of claim 1, wherein the first movement is characterized by an increase in acceleration in the x-axis, and a decrease in acceleration in the y-axis.

9. The method of claim 1, wherein the second movement is characterized by a decrease in acceleration in the x-axis, and an increase in acceleration in the y-axis.

10. The method of claim 1, wherein the first movement is characterized by a decrease in acceleration in the x-axis, and a decrease in acceleration in the y-axis.

11. The method of claim 1, wherein the second movement is characterized by an increase in acceleration in the x-axis, and an increase in acceleration in the y-axis.

12. An electronic device, comprising:
a display;
a memory configured to store logic instructions; and
a processor in communication with the display and the memory,
the processor, when executing the logic instructions, configured to:
detect a first movement of the electronic device;
detect a second movement of the electronic device; and
in response to the first movement and the second movement, cause groups of icons on the display to be re-arranged.

13. The electronic device of claim 12, wherein the processor is further configured to cause the groups of icons to re-arranged by rotating the groups of icons in one of a clockwise or counter clockwise direction around a predetermined center point.

14. The electronic device of claim 12, wherein the processor is further configured to group icons according to a quadrant in which the icons are displayed on the display.

15. The electronic device of claim 12, wherein the processor is further configured to determine that the second movement occurs within a predetermined time after the first movement.

16. The electronic device claim 12, further comprising an accelerometer configured to supply at least two axis of information to the processor.
